(19) United States
(12) Patent Application Publication
(10) Pub. No.: US 2007/0133685 A1
(43) Pub. Date: Jun. 14, 2007

(54) Motion estimating apparatus and motion estimating method

(75) Inventors: Hwa-seok Seong, Suwon-si (KR); Jong-sul Min, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/637,676

(22) Filed: Dec. 13, 2006

(30) Foreign Application Priority Data
Dec. 14, 2005 (KR) 2005-123392

(51) Int. Cl. H04N 11/02; H04N 11/04

(52) U.S. Cl. 375/240.16; 375/240.24

(57) ABSTRACT

An apparatus and method for estimating motion are provided. An exemplary motion estimating apparatus comprises a background representative calculator for calculating a background representative vector representing background motion of a frame to be interpolated on the basis of motion vectors of the frame to be interpolated, a block motion calculator for calculating motion vectors for respective blocks of the frame to be interpolated on the basis of a current frame and a previous frame, for providing the motion vectors to the background representative calculator, and for calculating background motion vectors for the respective blocks through local search on the basis of the background representative vector output from the background representative calculator, a motion error detector for determining whether each block is in a text area on the basis of the motion vectors and the background motion vectors output from the block motion calculator and a motion correcting unit for determining whether each block in the text area is in a boundary area on the basis of motion vectors of peripheral blocks of each block when each block is in the text area, and for correcting a motion vector of each block in the boundary area when each block in the text area is in the boundary area.

### CROSS-REFERENCE TO RELATED APPLICATIONS

This application claims the benefit under 35 U.S.C. §119(a) of Korean Patent Application No. 2005-0123392, filed on Dec. 14, 2005, in the Korean Intellectual Property Office, the entire disclosure of which is hereby incorporated by reference.

### BACKGROUND OF INVENTION

1. Field of Invention

The present invention relates to a motion estimating apparatus and a motion estimating method. More particularly, the present invention relates to a motion estimating apparatus and a motion estimating method for minimizing motion errors generated in a text area.

2. Description of the Related Art

In general, converting a frame rate using a frame rate converter in a display apparatus is effective regarding the timing adjustment, gray scale representation, and so on of a display panel. To this end, a method of estimating and compensating for motion using motion vectors of respective blocks in a frame rate converter and/or a deinterlacer has been proposed to display natural motion images. However, this motion estimation and compensation method has a limitation in practical use in that it is difficult to find correct motion vectors.

For example, scrolling text in a moving background has great difficulty in finding its motion vectors when the text moves in the moving background since the text itself has many similar edges.

Particularly, an image is likely to be distorted in a boundary area between a text area and a moving background due to motion estimation errors.

Accordingly, there is a need for an improved apparatus and method for estimating motion.

### SUMMARY OF THE INVENTION

Exemplary embodiments of the present invention address at least the above problems and/or disadvantages and provide at least the advantages described below. Accordingly, it is an object of the present invention to provide a motion estimating apparatus and a motion estimating method, which are capable of reducing distortion of an image in boundaries of text areas.

The foregoing and/or other exemplary aspects of the present invention can be achieved by providing a motion estimating apparatus comprising a background representative calculator for calculating a background representative vector representing background motion of a frame to be interpolated on the basis of motion vectors of the frame to be interpolated, a block motion calculator for calculating motion vectors for respective blocks of the frame to be interpolated on the basis of a current frame and a previous frame, providing the motion vectors to the background representative calculator, and calculating background motion vectors for the respective blocks through a local search on the basis of the background representative vector output from the background representative calculator, a motion error detector for determining whether each block is in a text area, on the basis of the motion vectors and the background motion vectors output from the block motion calculator, and a motion correcting unit for determining whether each block in the text area is in a boundary area on the basis of motion vectors of peripheral blocks of each block when each block is in the text area, and correcting a motion vector of each block in the boundary area when each block in the text area is in the boundary area.

According to an exemplary embodiment of the present invention, the background representative calculator may comprise a dispersion degree calculator for calculating a degree of dispersion between a motion vector of each block of a frame provided from the block motion calculator and motion vectors of peripheral blocks of each block, and detecting motion vectors having a degree of dispersion smaller than a reference value, a histogram generator for generating the detected motion vectors as a histogram and a representative deciding unit for deciding a vector which most frequently appears through the histogram, as the background representative vector.

According to an exemplary embodiment of the present invention, the block motion calculator may comprise a candidate vector calculator for calculating a plurality of candidate vectors with respect to each block of the frame to be interpolated on the basis of the current frame and the previous frame, a motion deciding unit for selecting one of the plurality of candidate vectors according to a criterion and deciding the selected candidate vector as a motion vector of each block and a background motion calculator for calculating a representative motion vector for each block through local search on the basis of the background representative vector output from the background representative calculator.

According to an exemplary embodiment of the present invention, the candidate vector calculator may comprise an average motion calculator for calculating an average motion vector on the basis of the motion vectors of the peripheral blocks of each block, a line motion calculator for generating a line motion vector in a search area on the basis of motion vectors of blocks in a horizontal direction, a zero motion calculator for calculating a zero motion vector at a location where no block motion occurs, and a full motion calculator for calculating a full motion vector through full search in the search area.

According to an exemplary embodiment of the present invention, the motion deciding unit may select and output, as a final motion vector of the block, one of the average motion vector, the line motion vector, the zero motion vector, and the full motion vector, on the basis of an average prediction error value according to the average motion vector, a line prediction error value according to the line motion vector, a zero prediction error value according to the zero motion vector, and a full prediction error value according to the full motion vector.

According to an exemplary embodiment of the present invention, the motion error detector may comprise a text area detector for determining whether each block is a text block, on the basis of the zero prediction error value, the full prediction error value, the decided motion vector, a prediction error value according to the motion vector, the background motion vector, and a prediction error value according to the background motion vector, a text flag generator for generating a text flag of the block when the block is the text block and a text mode deciding unit for counting the number of blocks in which the number of text flags per one frame successively exist, and outputting a text mode signal if the counted number exceeds a reference value.

According to an exemplary embodiment of the present invention, the text area detector determines that a block to be processed is the text block if the block to be processed satisfies the following Equation:
MV₀^{x}≠0 & MV₀^{y}≈0 or MV₀^{y}≠0 & MV₀^{x}≈0

where, MVₒ^{x} and MVₒ^{y} represent displacement in an x-direction and displacement in a y-direction of a motion vector MVₒ, respectively.

According to an exemplary embodiment of the present invention, the text area detector determines that the block to be processed is the text block if the block to be processed further satisfies the following Equation:
SAD_{fx}>>TH_{α} & SAD₀>α×SAD_{fs},

where, SAD_{fs} represents the minimum SAD value through full search, SAD₀ represents the minimum SAD value by a motion vector, and TH_{α} represents a threshold value, and α represents a weight.

According to an exemplary embodiment of the present invention, the text area detector determines that the block to be processed is the text block if the block to be processed further satisfies the following Equation:
SAD_{zero}>>β×SAD_{fs},

where, SAD_{ZERO} represents the minimum SAD value by the zero motion vector and β represents a weight.

According to an exemplary embodiment of the present invention, the text area detector determines that the block to be processed is the text block if the block to be processed further satisfies one of the following Equations a and b:
a. SAD_{b}>>ω×SAD_{fx} & MV_{b}≠MV₀ & SAD_{b}<SAD₀ or
a. SAD₀≈ρ×SAD_{fx} & MV_{b}≈MV₀ & SAD_{b}<SAD₀

where ω and ρ represent weights.

According to an exemplary embodiment of the present invention, the text mode deciding unit determines that corresponding blocks are in the text area when at least three text flags successively exist, and enables the text flags for the blocks.

According to an exemplary embodiment of the present invention, the motion correcting unit may comprise a boundary area detector for projecting motion vectors of peripheral blocks of a block in the text area in an x-axis direction and a y-axis direction to calculate average vectors, calculating degrees of dispersion of the average vectors, and determining that the block is the boundary block if an average vector having the greatest dispersion degree among the average vectors is greater than a reference value.

According to an exemplary embodiment of the present invention, the motion correcting unit may comprise a vector correcting unit for correcting a motion vector of the boundary block to be an average vector having the greatest difference from the background motion vector among the calculated average vectors.

According to an exemplary embodiment of the present invention, the motion estimating apparatus may further comprise a frame interpolator for generating the frame to be interpolated on the basis of the corrected motion vector.

The foregoing and/or other exemplary aspects of the present invention can be achieved by providing a motion estimating method comprising calculating and outputting a motion vector for each block of a frame to be interpolated on the basis of a current frame and a previous frame, calculating a background representative vector representing background motion of the frame to be interpolated on the basis of motion vectors of the frame to be interpolated, calculating a background motion vector for the each blocks through local search on the basis of the background representative vector, determining whether each block is in a text area on the basis of the motion vector and the background motion vector and determining whether the block in the text area is in a boundary area on the basis of motion vectors of peripheral blocks of the block in the text area, when each block is in the text area, and correcting a motion vector of the block in the boundary area when the block in the text area is in the boundary area.

According to an exemplary embodiment of the present invention, the calculating of the background representative vector may comprise calculating a degree of dispersion between a motion vector of each block of each frame and motion vectors of peripheral blocks of the each block, detecting vectors having a degree of dispersion smaller than a reference value, and generating a histogram and deciding a vector which most frequently appears through the histogram, as the background representative vector.

According to an exemplary embodiment of the present invention, the calculating of the motion vectors of each block may comprise calculating a plurality of candidate vectors for each block of the frame to be interpolated on the basis of the current frame and the previous frame, selecting one of the plurality of candidate vectors according to a criterion and deciding the selected candidate vector as the motion vector of each block and calculating a representative motion vector for each block through local search on the basis of the calculated background representative vector.

According to an exemplary embodiment of the present invention, the calculating of the plurality of candidate vectors may comprise calculating an average motion vector on the basis of the motion vectors of the peripheral blocks of each block, generating a line motion vector in a search area on the basis of motion vectors of blocks in a horizontal direction, calculating a zero motion vector at a location where no block motion occurs and calculating a full motion vector through full search in the search area.

According to an exemplary embodiment of the present invention, the selecting of the one of the plurality of candidate vectors and deciding the selected candidate vector as the motion vector of each block may comprise selecting and outputting, as the motion vector of each block, one of the average motion vector, the line motion vector, the zero motion vector, and the full motion vector, on the basis of an average prediction error value according to the average motion vector, a line prediction error value according to the line motion vector, a zero prediction error value according to the zero motion vector, and a full prediction error value according to the full motion vector.

According to an exemplary embodiment of the present invention, the determining of whether each block is in the text area may comprise detecting whether each block is in the text area on the basis of the zero prediction error value, the full prediction error value, the decided motion vector, a prediction error value according to the motion vector, the background motion vector, and a prediction error value according to the background motion vector, generating a text flag of the block if the block is in the text area, and counting the number of blocks in which the number of text flags per one frame successively exist, and outputting a text mode signal if the counted number is greater than a reference value.

According to an exemplary embodiment of the present invention, the determining of whether each block is in the text area may comprise determining that each block is in the text area if each block satisfies the following Equations:
MV₀^{x}≠0 & MV₀^{y}≈0 or MV₀^{y}≠0 & MV₀^{x}≈0,
SAD_{fx}>>TH_{α}& SAD₀>α×SAD_{fs},
SAD_{zero}>>β×SAD_{fs},
a. SAD_{b}>ω×SAD_{fx} & MV_{b}≠MV₀ & SAD_{b}<SAD₀ or
a. SAD₀≈ρ×SAD_{fx} & MV_{b}≈MV₀ & SAD_{b}<SAD₀

According to an exemplary embodiment of the present invention, the counting of the number of blocks and the outputting of the text mode signal may comprise determining that blocks in which three text flags successively exist are in the text area, and enabling text flags of the blocks.

According to an exemplary embodiment of the present invention, the correcting of the motion vector may comprise calculating average vectors by projecting motion vectors of peripheral blocks of the block in an x-axis direction and a y-axis direction if the block is in the text area, calculating degrees of dispersion of the calculated average vectors and determining that the block in the text area is in the boundary area if an average vector having the greatest dispersion degree among the average vectors is greater than a reference value.

According to an exemplary embodiment of the present invention, the correcting of the motion vector may comprise correcting a motion vector of the block in the boundary area to be an average vector having the greatest difference from the background motion vector among the calculated average vectors, when the block in the text area is in the boundary area.

According to an exemplary embodiment of the present invention, the motion estimating method may further comprise generating the frame to be interpolated on the basis of the corrected motion vector.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a control block diagram of a motion estimating apparatus according to an exemplary embodiment of the present invention;

FIG. 2 is a detailed block diagram of a block motion calculator according to an exemplary embodiment of the present invention;

FIG. 3 is a detailed block diagram of a background representative calculator according to an exemplary embodiment of the present invention;

FIG. 4 is a detailed block diagram of a motion error detector and a motion correcting unit according to an exemplary embodiment of the present invention;

FIG. 5 is a flowchart illustrating a method in which the motion error detector determines whether a block is in a text area and a text mode according to an exemplary embodiment of the present invention;

FIG. 6 is a view for explaining a motion correction method performed by the motion correcting unit according to an exemplary embodiment of the present invention; and

FIG. 7 is a view showing a non-corrected image and a resultant image corrected according to the exemplary motion estimating method by the motion estimating apparatus.

Throughout the drawings, the same drawing reference numerals will be understood to refer to the same elements, features, and structures.

### DETAILED DESCRIPTION EXEMPLARY EMBODIMENTS

The matters defined in the description such as a detailed construction and elements are provided to assist in a comprehensive understanding of embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Reference will now be made in detail to exemplary embodiments of the present invention which are illustrated in the accompanying drawings.

A motion estimating apparatus and a motion estimating method for minimizing distortion of an image due to motion errors in a text area, according to exemplary embodiments of the present invention, introduce the following assumptions.

<Assumption 1> A text area belongs to an object area which can be separated from a background area.

<Assumption 2> A text scrolled on a screen has uni-directional motion.

<Assumption 3> A scrolled text may be inserted into an original image.

<Assumption 4> A scrolled text moves with continuity on an area.

<Assumption 5> A text area has a difference in brightness from a background area.

<Assumption 6> Distortion generated in a text area is significant in a boundary having a different motion vector.

Under the above assumptions, in the motion estimating apparatus and motion estimating method, according to exemplary embodiments of the present invention, an object area is separated from a background area, a text area of the object area is detected, a boundary area having different motion of the text area is detected, and motion vectors of the boundary area are corrected.

Hereinafter, exemplary embodiments of the present invention will be described in detail with reference to the appended drawings.

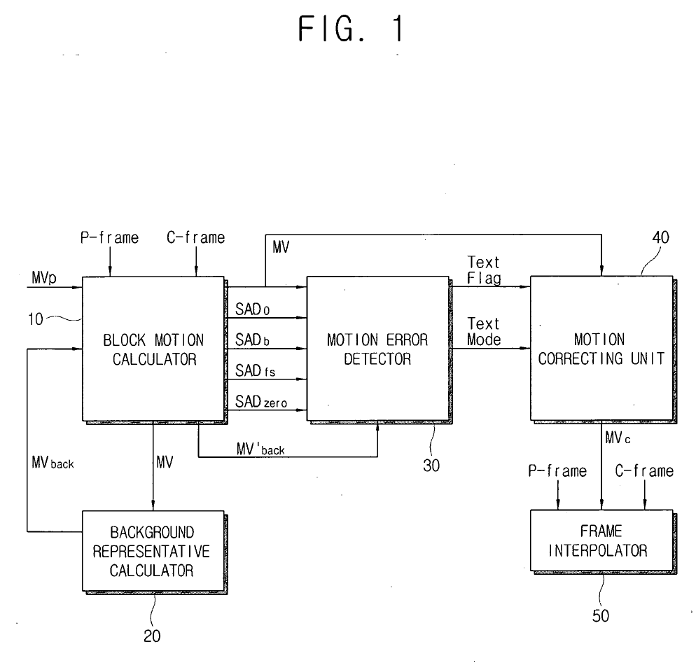

FIG. 1 is a control block diagram of a motion estimating apparatus according to an exemplary embodiment of the present invention. Referring to FIG. 1, the motion estimating apparatus may include a block motion calculator 10, a background representative calculator 20, a motion error detector 30, and a motion correcting unit 40.

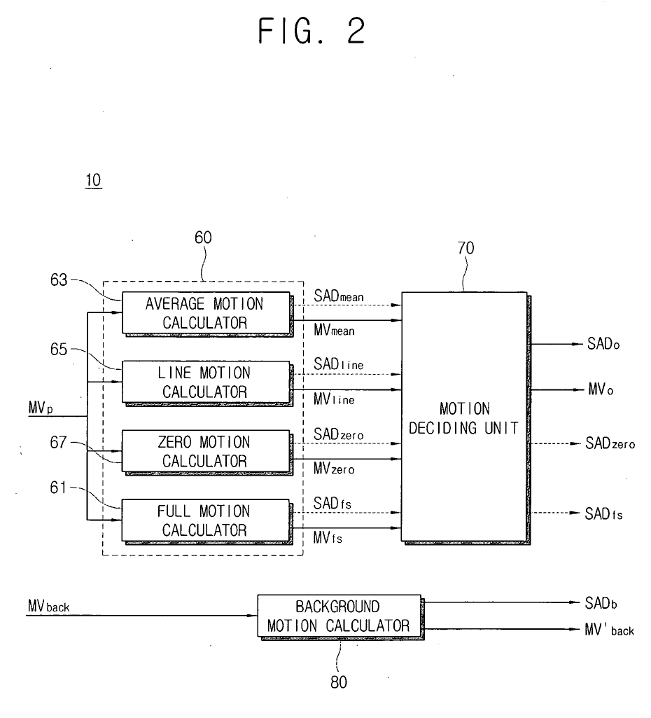

The block motion calculator 10 calculates motion vectors corresponding to blocks of a frame to be interpolated, on the basis of a current frame and a previous frame. The block motion calculator 10 will be described in detail with reference to FIG. 2.

Referring to FIG. 2, the block motion calculator 10 includes a candidate vector calculator 60 and a motion deciding unit 70. The candidate vector calculator 60 calculates a plurality of candidate vectors corresponding to each block, on the basis of the current frame and the previous frame. The motion deciding unit 70 decides one of the plurality of candidate vectors as a motion vector, according to a criterion.

As illustrated in FIG. 2, the candidate vector calculator 60 may include a full motion calculator 61, an average motion calculator 63, a line motion calculator 65, and a zero motion calculator 67.

The full motion calculator 61 divides the current frame into a plurality of blocks, each block having a size, and compares a block to be motion-estimated in the current frame (hereinafter, referred to as a “current block”), with a search area of the previous frame in order to estimate a full motion vector MV_{f}.

The full motion calculator 61 applies a full search block matching (FSBM) algorithm to calculate a plurality of motion prediction error values. The full motion calculator 61 estimates full motion vectors MV_{fs} of respective blocks from a location having a minimum motion prediction error value. The motion prediction error value can be calculated by various methods, such as a sum of absolute difference (SAD) method, a mean absolute difference (MAD) method, and the like.

The average motion calculator 63 calculates an average vector of motion vectors of peripheral blocks adjacent to the current block, on the basis of the full motion vectors MV_{fs} received from the full motion calculator 61. That is, the average motion calculator 63 configures a window having an M×N size including the current block and calculates an average vector of motion vectors included in the window.

For example, the window may have a 3×3 size. A larger window size reflects the entire motion better.

The average motion calculator 63 can accumulate motion vectors of blocks of the previous frame to obtain an average motion vector MVₘₑₐₙ in order to simplify hardware configuration and reduce a calculation time. That is, it is required to calculate motion vectors after the current block in order to obtain the full motion vector MV_{f}, which increases a time delay. For this reason, the average motion vector MVₘₑₐₙ is obtained using motion vectors of blocks of the previous frame.

The line motion calculator 65 calculates a line motion vector MVₗᵢₙₑ representing a degree of horizontal motion of the current block, using motion vectors of blocks which are successively arranged in a horizontal direction.

The line motion vector MVₗᵢₙₑ can be obtained by the following Equations 1 and 2.

$$\begin{matrix}MV\_Avg ( n ) = {\sum }_{i = 0}^{N} MotionVector ( i , n ) & [ Equation 1 ] \\ LineMV ( n ) = Local Min ( MV\_Avg ( n ) , Search\_Range ) & [ Equation 2 ]\end{matrix}$$

Where, n represents an index of a block in the vertical direction, and i represents an index of a block in the horizontal direction.

As seen from Equation 1, the line motion calculator 65 calculates a line average motion vector MV_Avg(n) on the basis of motion vectors of blocks on a line to which the current block belongs.

In an exemplary embodiment, the operation is performed under the assumption that motion errors in full motion in which a plurality of blocks representing the same object move together have a Gaussian distribution. An average value of motion vectors of blocks subjected to full motion almost approximates actual full motion. As the number of the blocks used to obtain the average value increases, accuracy becomes higher.

For example, since a text scroll in news and so on occupies most of the lower region of the screen, if it is assumed that a standard definition (SD) level of 480 pixels is used and the size of each block is 8×8, the number of the blocks is 480/8, in other words, 60. Accordingly, when a text scroll is actually generated, a motion vector similar to actual correct motion can be obtained by averaging the motion vectors of the corresponding blocks.

The line motion calculator 65 obtains local minima within a search area, centering on the average value obtained by Equation 1, and calculates the local minima as the line motion vector MVₗᵢₙₑ.

The operation is performed under the assumption that a correct motion vector exists around the local minima among SAD values in the search area. Actual SAD values indicate that local minima exist where the blocks are approximately matched.

If the search area has an N×M size in a full search method for calculating the full motion vectors MV_{fs}, a smaller search range, such as N/2×M/2 or the like, may be used to obtain the line motion vector MVₗᵢₙₑ.

The zero motion calculator 67 finds local minima within a small search area, centering on a location at which a motion vector is zero, and calculates the found local minina as a zero motion vector MV_{zero}. In an exemplary embodiment, the zero motion calculator 67 obtains local minima within an M×M search area, centering on a specific location (a zero motion vector (0,0)), like the line motion vector MVₗᵢₙₑ.

This is because obtaining a SAD value from local minima around the motion vector (0,0), rather than merely obtaining a SAD value for the motion vector (0,0), is effective in minimizing influence of noise or the like.

The motion deciding unit 70 receives the full motion vector MV_{f}, the average motion vector MVₘₑₐₙ, the line motion vector MVₗᵢₙₑ, and the zero motion vector MV_{zero}, and selects and outputs one of these vectors as a motion vector. In more detail, the motion deciding unit 70 compares a full SAD value SAD_{fs} according to the full motion vector MV_{f}, an average SAD value SADₘₑₐₙ according to the average motion vector MVₘₑₐₙ, a line SAD value SADₗᵢₙₑ according to the line motion vector MVₗᵢₙₑ, and a zero SAD value SAD_{zero} according to the zero motion vector MV_{zero} with one another. Based on a result of the comparison by the motion deciding unit 70, a multiplexer selects and outputs a motion vector corresponding to a minimum SAD value of the SAD values as a final motion vector. In an exemplary embodiment, it is possible to give priorities to the motion vectors by adjusting weights by which the respective SAD values will be multiplied.

Hardware configuration needs to be simplified to obtain such motion vectors. This requires sharing motion estimation. The processes in which the average motion calculator 63, the line motion calculator 65, and the zero motion calculator 76 respectively obtain the local minima can be shared in a full search motion estimator.

The average motion calculator 63 obtains local minima around the average vector MVₘₑₐₙ having a size (for example, 3×3), the line motion calculator 65 obtains local minima around the line average vector MVₗᵢₙₑ, and the zero motion calculator 67 obtains local minima around the zero vector MV_{zero}. Thus, if the full search motion estimator sets the respective search areas, SAD values in the corresponding search areas can be calculated and stored.

Accordingly, the average motion vector, the zero motion vector, and the line motion vector can be calculated by only the full search motion estimator. In an exemplary embodiment, since motion estimation through full search is performed by the full motion calculator 61, the respective motion vectors can be extracted by sharing the hardware of the full motion calculator 61.

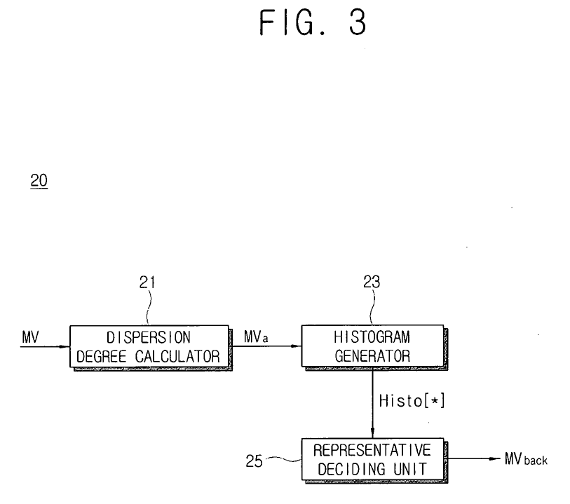

The background representative calculator 20 detects a vector, which is the highest in correlativity between peripheral motion vectors of the current motion vector and which most frequently appears among the peripheral vectors, as a background representative vector of the corresponding frame, on the basis of motion vectors output from the block motion calculator 10. In more detail, as illustrated in FIG. 3, the background representative calculator 20 includes a dispersion degree calculator 21, a histogram generator 23, and a representative deciding unit 25.

In an exemplary embodiment, the dispersion degree calculator 21 calculates a degree of dispersion between a received motion vector and peripheral motion vectors according to the following Equation 3, and detects motion vectors MVₐ having a degree of dispersion smaller than a reference value.

$${D}_{niv} = {\sum }_{i = 1}^{n} \vert {MV}_{c} - {MV}_{i} \vert \qquad [ Equation 3 ]$$

Where, Dₘᵥ represents a degree of dispersion of a motion vector, MV_{c} represents a motion vector of a current block to be processed, and MVᵢ represents peripheral motion vectors of the current block.

If the motion vectors MVₐ detected by the dispersion degree calculator 21 are generated and stored as a motion vector histogram by the histogram generator 23, the representative deciding unit 25 decides, as a background representative vector MV_{back}, a motion vector which most frequently appears in the motion vector histogram generated by the histogram generator 23.

In an exemplary embodiment, the block motion calculator 10 may further include a background motion calculator 80, as illustrated in FIG. 2. The background motion calculator 80 calculates background motion vectors MV′_{back} of respective blocks through local search in an area on the basis of the background representative vector MV_{back} output from the background representative calculator 20.

In an exemplary embodiment, the motion error detector 30 detects a text area on the basis of the motion vector MV_{O}, the minimum SAD SAD_{O} according to the motion vector MV_{O}, the background motion vector MV_{back}, the minimum SAD value SAD_{b} according to the background motion vector MV_{back}, the minimum SAD value SAD_{f} according to the full motion vector MV_{f}, and the zero SAD value SAD_{ZERO}, all of which are output from the block motion calculator 10.

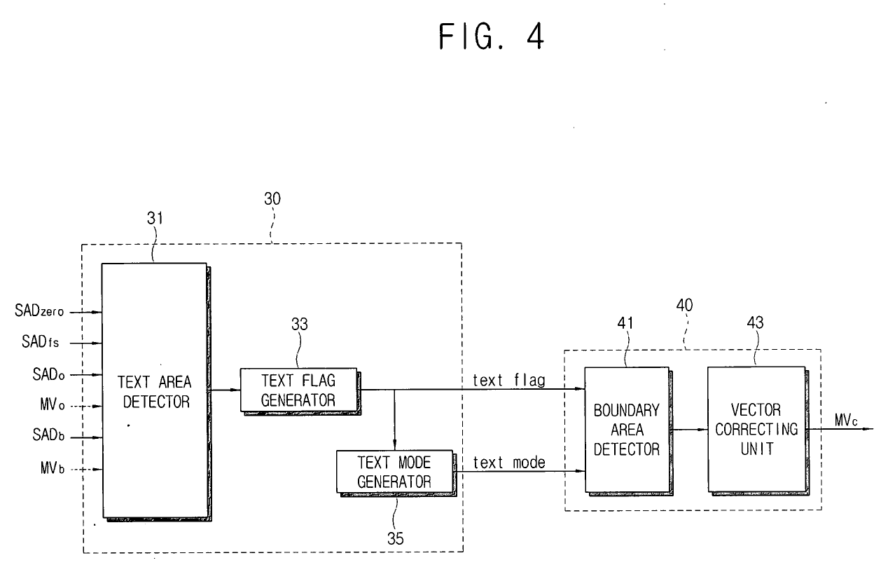

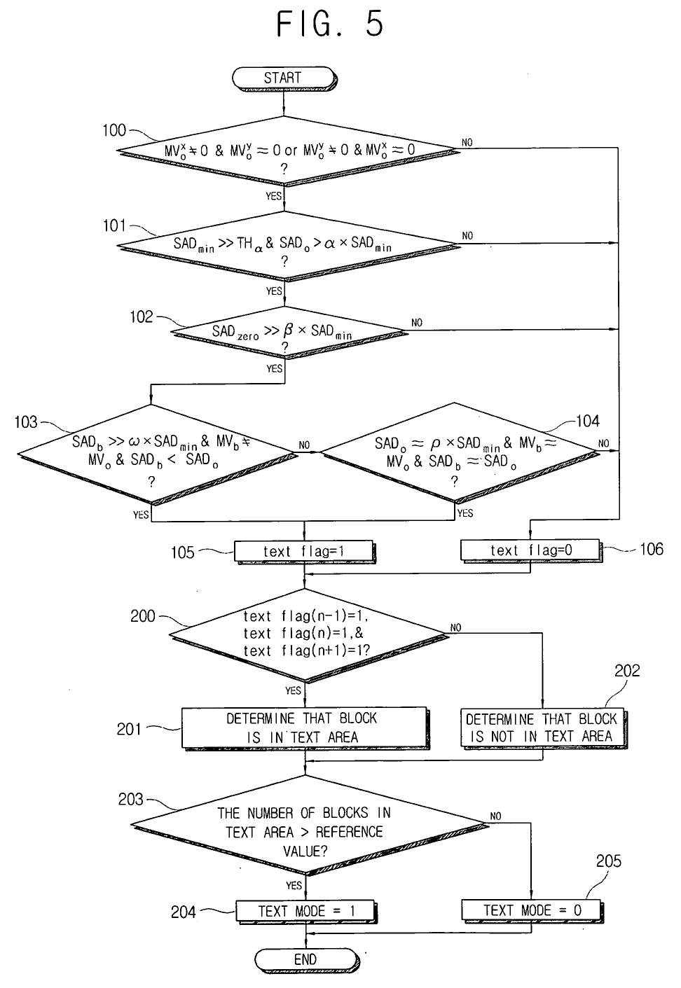

The motion error detector 30 will be described in more detail with reference to FIGS. 4 and 5.

Referring to FIG. 4, the motion error detector 30 includes a text area detector 31, a text flag generator 33, and a text mode generator 35.

The text area detector 31 determines whether each block satisfies certain Equations. The text area detector 31 determines whether each block is a text block through operations 100 through 105 illustrated in FIG. 5. The Equations are defined as follows.
MV₀^{x}≠0 & MV₀^{y}≈0 or MV₀^{y}≠0 & MV₀^{x}≈0 [Equation 4]
SAD_{fx}>>TH_{α} & SAD₀>α×SAD_{fs} [Equation 5]
SAD_{zero}>>β×SAD_{fs} [Equation 6]
a. SAD_{b}>>ω×SAD_{fx} & MV_{b}≠MV₀ & SAD_{b}<SAD₀ or
a. SAD₀≈ρ×SAD_{fx} & MV_{b}≈MV₀ & SAD_{b}<SAD₀ [Equation 7]

Where, MVₒ^{x} and MVₒ^{y} respectively represent x and y directional displacements of the motion vector MV_{O}, TH_{α} represents a threshold value, and α, β, ?, and ? represent weights.

First, at operation 100, the text area detector 31 determines whether the motion vector MV_{O} satisfies Equation 4 that models the above-mentioned <Assumption 2> to express a uni-directional characteristic that the motion vector MV_{O} representing motion of an object has only x directional motion or y directional motion.

Then, at operation 101, it is determined whether Equation 5 that models the above-mentioned <Assumption 3> is satisfied. When block matching is tried using two frame data having the same motion in a text area which is inserted into an original scene, an area not existing in the original scene is newly created or an existing area disappears, thus increasing the minimum SAD value. As a result, the SAD value SAD_{O} by the motion vector MV_{O} representing the motion of the object area becomes greater than SAD_{fs} which is the minimum SAD value by full search.

Next, at operation 102, the text area detector 31 determines whether Equation 6 that models the above-mentioned <Assumption 5> is satisfied. The zero SAD value SAD_{ZERO} is a sum of brightness differences between two frames with respect to blocks where no motion occurs. In a text area having brightness higher than its peripheral area, the zero SAD value SAD_{ZERO} will have a large value.

Next, at operations 103 and 104, it is determined whether Equation 7 that models the above-mentioned <Assumption 1> to detect an object area is satisfied. Here, Equation 7 is defined separately considering a case when the motion of the background is different from the motion of the object (operation 103) and a case when the motion of the background is similar to the motion of the object (operation 104).

Part a of Equation 7 corresponds to the case when the motion of the background is different from the motion of the object, specifically when the background motion vector MV_{b} representing the motion of the background is different from the motion vector MV_{O} representing the motion of the object. Also, since an area corresponding to the case belongs to the object area, the minimum SAD value SAD_{b} calculated by the background motion vector MV_{b} is greater than the minimum SAD value SAD_{O} calculated by the motion vector MV_{O} of the object, and a difference between the minimum SAD value SAD_{b} and the minimum SAD value SADₘᵢₙ by full search is large.

On the other hand, part b of Equation 7 corresponds to the case when the motion of the background is similar to the motion of the object, specifically when the background motion vector MV_{b} representing the motion of the background is similar to the motion vector MV_{O} representing the motion of the object, and accordingly, the minimum SAD value SAD_{b} is similar to the minimum SAD value SAD_{O}. However, since an area corresponding to the case belongs to a boundary between the background and the object, the minimum SAD value SAD_{b} or SAD_{O} has a large difference from the minimum SAD value SAD_{fs} by full search.

If all Equations described above are satisfied, the text flag generator 33 sets a text flag for the corresponding block to 1 at operation 105. Otherwise, the text flag generator 33 sets a text flag for the corresponding block to 0 at operation 106.

Next, at operation 200, the text mode generator 35 determines whether at least three text flags successively exist in a block. If at least three text flags successively exist in the block, the text mode generator 35 determines the block as a text area at operation 201 and enables the text flags. Otherwise, the text flag is disabled, and it is determined that the corresponding block is not the text area although the corresponding block satisfies Equations 4 through 7 at operation 202. Equations used for the text mode generator 35 at the operation 200 correspond to the above-mentioned <Assumption 4>.

Also, if the number of blocks in the text area (that is, the number of blocks having text flags enabled to 1) exceeds a reference value for each frame at operation 203, the text mode generator 35 sets a text mode signal to 1 at operation 204. Otherwise, the text mode generator 35 sets the text mode signal to 0 at operation 205.

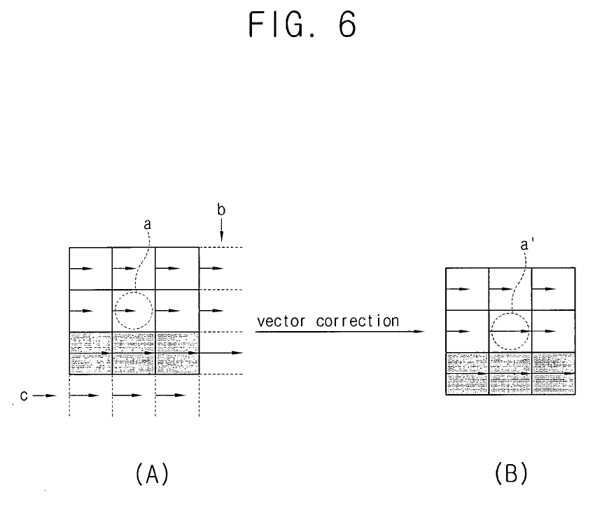

In an exemplary embodiment, the motion correcting unit 40 determines whether the blocks in the text area belong to a boundary area between the background and the object, and corrects motion vectors of the blocks if the blocks in the text area belong to the boundary area. The motion correcting unit 40 will be described in more detail with reference to FIGS. 4 and 6.

As illustrated in FIG. 4, the motion correcting unit 40 includes a boundary area detector 41 and a vector correcting unit 43.

The boundary area detector 41 determines whether blocks having text flags enabled to 1 are in the boundary area, with respect to frames which are in a text mode set to 1.

First, as illustrated in (A) of FIG. 6, the boundary area detector 41 configures a window having a 3×3 size centering on a block to be processed, and projects motion vectors in x and y directions. Then, the boundary area detector 41 obtains averages of vectors existing in the projection directions. Then, the boundary area detector 41 obtains a degree of dispersion of average vectors b in the x direction and a degree of dispersion of average vectors c in the y direction, according to the projection directions. That is, the greater the degree of dispersion, the greater the difference between motion vectors. For example, if the degrees of dispersion with respect to two projection directions are D and E, a direction corresponding to the greater one of the values D and E is selected. If the selected degree of dispersion is greater than a reference value, it is determined that the corresponding area is the boundary area between the object and the background. In FIG. 6, since a degree of dispersion of motion vectors projected in the x direction is greater than a degree of dispersion of motion vectors projected in the y direction, it is determined that a boundary exists in the x direction. The determination of the boundary area detector 41 corresponds to the above-mentioned <Assumption 6>.

The vector correcting unit 43 corrects a motion vector of a block to be processed to be a vector having the greatest value among average vectors which exist in the selected direction, in the boundary area. As illustrated in FIG. 6, a motion vector a of a center block is corrected to be the lowest vector a' having the greatest value among average vectors projected in the x direction. Motion vectors of blocks which are in neither the text area nor the boundary area are not subjected to correction by the motion correcting unit 40.

In an exemplary embodiment, the motion estimating apparatus may include a frame interpolator 50, as illustrated in FIG. 1. The frame interpolator 50 corrects and outputs data of an interpolation frame to be inserted between the current frame and the previous frame on the basis of motion vectors which are corrected or not corrected.

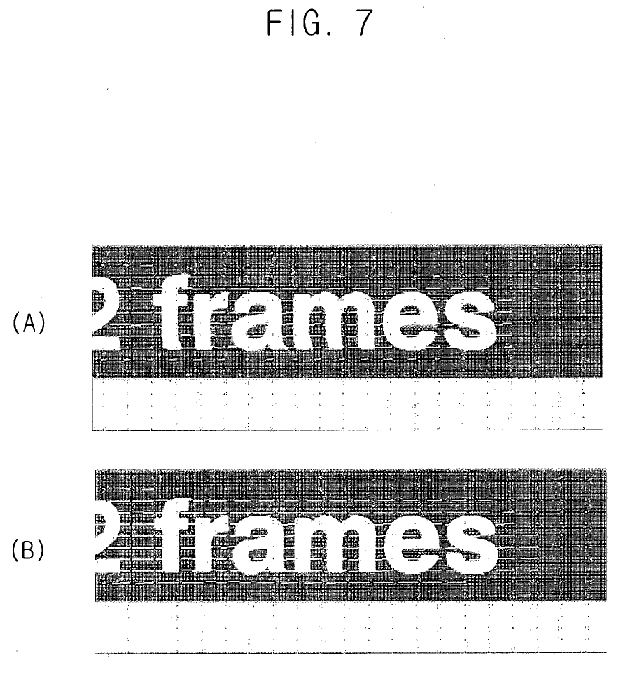

Referring to FIG. 7, an image (A) to which the present invention is not applied and an image (B) to which an exemplary embodiment of the present invention is applied are significantly different in the boundary area of text. As such, by minimizing motion errors in processing a boundary area between an object area and a background area, image distortion in the boundary area can be minimized.

In exemplary embodiments as described above, the candidate vector calculator 60 generates four candidate vectors, however, the present invention is not limited to this. Also, the text mode generator 35 determines that the corresponding blocks are in a text area when text flags of at least three blocks are 1. However, it is also possible to determine that the corresponding blocks are in a text area when text flags of the different number of blocks are 1.

As apparent from the above description, the present invention provides a motion estimating apparatus and a motion estimating method for reducing distortion of an image in boundaries of text areas.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A motion estimating apparatus comprising:
a background representative calculator for calculating a background representative vector representing background motion of a frame to be interpolated on the basis of motion vectors of the frame to be interpolated;
a block motion calculator for calculating motion vectors for respective blocks of the frame to be interpolated on the basis of a current frame and a previous frame, for providing the motion vectors to the background representative calculator, and for calculating background motion vectors for the respective blocks through local search on the basis of the background representative vector output from the background representative calculator;
a motion error detector for determining whether each block is in a text area on the basis of the motion vectors and the background motion vectors output from the block motion calculator; and
a motion correcting unit for determining whether each block in the text area is in a boundary area on the basis of motion vectors of peripheral blocks of each block when each block is in the text area, and correcting a motion vector of each block in the boundary area when each block in the text area is in the boundary area.

2. The motion estimating apparatus according to claim 1, wherein the background representative calculator comprises:
a dispersion degree calculator for calculating a degree of dispersion between a motion vector of each block of a frame provided from the block motion calculator and motion vectors of peripheral blocks of each block, and for detecting motion vectors having a degree of dispersion smaller than a reference value;
a histogram generator for generating the detected motion vectors as a histogram; and
a representative deciding unit for deciding a vector which most frequently appears through the histogram as the background representative vector.

3. The motion estimating apparatus according to claim 1, wherein the block motion calculator comprises:
a candidate vector calculator for calculating a plurality of candidate vectors with respect to each block of the frame to be interpolated on the basis of the current frame and the previous frame;
a motion deciding unit for selecting one of the plurality of candidate vectors according to a criterion and deciding the selected candidate vector as a motion vector of each block; and
a background motion calculator for calculating a representative motion vector for the each block through local search on the basis of the background representative vector output from the background representative calculator.

4. The motion estimating apparatus according to claim 3, wherein the candidate vector calculator comprises:
an average motion calculator for calculating an average motion vector on the basis of the motion vectors of the peripheral blocks of each block;
a line motion calculator for generating a line motion vector in a search area on the basis of motion vectors of blocks in a horizontal direction;
a zero motion calculator for calculating a zero motion vector at a location where no block motion occurs; and
a full motion calculator for calculating a full motion vector through full search in the search area.

5. The motion estimating apparatus according to claim 4, wherein the motion deciding unit selects and outputs, as a final motion vector of the block, at least one of the average motion vector, the line motion vector, the zero motion vector, and the full motion vector, on the basis of an average prediction error value according to the average motion vector, a line prediction error value according to the line motion vector, a zero prediction error value according to the zero motion vector, and a full prediction error value according to the full motion vector.

6. The motion estimating apparatus according to claim 5, wherein the motion error detector comprises:
a text area detector for determining whether the each block is a text block, on the basis of at least one of the zero prediction error value, the full prediction error value, the decided motion vector, a prediction error value according to the motion vector, the background motion vector, and a prediction error value according to the background motion vector;
a text flag generator for generating a text flag of the block when the block is the text block; and
a text mode deciding unit for counting the number of blocks in which the number of text flags per one frame successively exist, and for outputting a text mode signal if the counted number exceeds a reference value.

7. The motion estimating apparatus according to claim 6, wherein the text area detector determines that a block to be processed is the text block if the block to be processed satisfies the following Equation:
MV₀^{x}≠0 & MV₀^{y}≈0 or MV₀^{y}≠0 & MV₀^{x}≈0
where, MVₒ^{x} and MVₒ^{y} represent displacement in an x-direction and displacement in a y-direction of a motion vector MVₒ, respectively.

8. The motion estimating apparatus according to claim 7, wherein the text area detector determines that the block to be processed is the text block if the block to be processed further satisfies the following Equation:
SAD_{fx}>>TH_{α} & SAD₀>α×SAD_{fs}
where, SAD_{fs} represents the minimum SAD value through full search, SAD₀ represents the minimum SAD value by a motion vector, TH_{α} represents a threshold value, and α represents a weight.

9. The motion estimating apparatus according to claim 8, wherein the text area detector determines that the block to be processed is the text block if the block to be processed further satisfies the following Equation:
SAD_{zero}>>β×SAD_{fs}
where, SAD_{ZERO} represents the minimum SAD value by the zero motion vector and β represents a weight.

10. The motion estimating apparatus according to claim 9, wherein the text area detector determines that the block to be processed is the text block if the block to be processed further satisfies one of the following Equations a and b:
a. SAD_{b}>>ω×SAD_{fx} & MV_{b}≠MV₀ & SAD_{b}<SAD₀ or
a. SAD₀≈ρ×SAD_{fx} & MV_{b}≈MV₀ & SAD_{b}<SAD₀
where ω and ρ represent weights.

11. The motion estimating apparatus according to claim 10, wherein the text mode deciding unit determines that corresponding blocks are in the text area when at least three text flags successively exist, and enables the text flags for the blocks.

12. The motion estimating apparatus according to claim 11, wherein the motion correcting unit comprises a boundary area detector for projecting motion vectors of peripheral blocks of a block in the text area in an x-axis direction and a y-axis direction to calculate average vectors, calculating degrees of dispersion of the average vectors, and determining that the block is the boundary block if an average vector having the greatest dispersion degree among the average vectors is greater than a reference value.

13. The motion estimating apparatus according to claim 12, wherein the motion correcting unit comprises a vector correcting unit for correcting a motion vector of the boundary block to be an average vector having the greatest difference from the background motion vector among the calculated average vectors.

14. The motion estimating apparatus according to claim 1, wherein the motion correcting unit comprises a boundary area detector for projecting motion vectors of peripheral blocks of a block in the text area in an x-axis direction and a y-axis direction to calculate average vectors, calculating degrees of dispersion of the average vectors, and determining that the block is the boundary block if an average vector having the greatest dispersion degree among the average vectors is greater than a reference value.

15. The motion estimating apparatus according to claim 14, wherein the motion correcting unit comprises a vector correcting unit for correcting a motion vector of the boundary block to be an average vector having the greatest difference from the background motion vector among the calculated average vectors.

16. The motion estimating apparatus according to claim 13, further comprising a frame interpolator for generating the frame to be interpolated on the basis of the corrected motion vector.

17. The motion estimating apparatus according to claim 15, further comprising a frame interpolator for generating the frame to be interpolated on the basis of the corrected motion vector.

18. The motion estimating apparatus according to claim 1, further comprising a frame interpolator for generating the frame to be interpolated on the basis of the corrected motion vector.

19. A motion estimating method comprising:
calculating and outputting a motion vector for each block of a frame to be interpolated on the basis of a current frame and a previous frame;
calculating a background representative vector representing background motion of the frame to be interpolated on the basis of motion vectors of the frame to be interpolated;
calculating a background motion vector for each block through local search on the basis of the background representative vector;
determining whether each block is in a text area on the basis of the motion vector and the background motion vector; and
determining whether the block in the text area is in a boundary area on the basis of motion vectors of peripheral blocks of the block in the text area, when each block is in the text area, and correcting a motion vector of the block in the boundary area when the block in the text area is in the boundary area.

20. The motion estimating method according to claim 19, wherein the calculating of the background representative vector comprises:
calculating a degree of dispersion between a motion vector of each block of each frame and motion vectors of peripheral blocks of each block;
detecting vectors having a degree of dispersion smaller than a reference value, and generating a histogram; and
deciding a vector which most frequently appears through the histogram as the background representative vector.

21. The motion estimating method according to claim 20, wherein the calculating of the motion vectors of each block comprises:
calculating a plurality of candidate vectors for each block of the frame to be interpolated on the basis of the current frame and the previous frame;
selecting one of the plurality of candidate vectors according to a criterion and deciding the selected candidate vector as the motion vector of each block; and
calculating a representative motion vector for each block through local search on the basis of the calculated background representative vector.

22. The motion estimating method according to claim 21, wherein the calculating of the plurality of candidate vectors comprises:
calculating an average motion vector on the basis of the motion vectors of the peripheral blocks of each block;
generating a line motion vector in a search area on the basis of motion vectors of blocks in a horizontal direction;
calculating a zero motion vector at a location where no block motion occurs; and
calculating a full motion vector through full search in the search area.

23. The motion estimating method according to claim 22, wherein the selecting of the one of the plurality of candidate vectors and deciding of the selected candidate vector as the motion vector of the each block comprises selecting and outputting, as the motion vector of each block, at least one of the average motion vector, the line motion vector, the zero motion vector, and the full motion vector, on the basis of an average prediction error value according to the average motion vector, a line prediction error value according to the line motion vector, a zero prediction error value according to the zero motion vector, and a full prediction error value according to the full motion vector.

24. The motion estimating method according to claim 23, wherein the determining of whether each block is in the text area comprises:
detecting whether each block is in the text area, on the basis of at least one of the zero prediction error value, the full prediction error value, the decided motion vector, a prediction error value according to the motion vector, the background motion vector, and a prediction error value according to the background motion vector;
generating a text flag of the block if the block is in the text area; and
counting the number of blocks in which the number of text flags per one frame successively exist, and outputting a text mode signal if the counted number is greater than a reference value.

25. The motion estimating method according to claim 24, wherein the determining of whether each block is in the text area comprises determining that each block is in the text area if each block satisfies the following Equations:
MV₀^{x}≠0 & MV₀^{y}≈0 or MV₀^{y}≠0 & MV₀^{x}≠0,
SAD_{fx}>>TH_{α} & SAD₀>α×SAD_{fs},
SAD_{zero}>>β×SAD_{fs},
a. SAD_{b}>>ω×SAD_{fx} & MV_{b}≠MV₀ & SAD_{b}<SAD₀ or
a. SAD₀≈ρ×SAD_{fx} & MV_{b}≈MV₀ & SAD_{b}<SAD₀

26. The motion estimating method according to claim 25, wherein the counting of the number of blocks and the outputting of the text mode signal comprises determining that blocks in which three text flags successively exist are in the text area, and enabling text flags of the blocks.

27. The motion estimating method according to claim 26, wherein the correcting of the motion vector comprises:
calculating average vectors by projecting motion vectors of peripheral blocks of the block in an x-axis direction and a y-axis direction if the block is in the text area; and
calculating degrees of dispersion of the calculated average vectors, and determining that the block in the text area is in the boundary area if an average vector having the greatest dispersion degree among the average vectors is greater than a reference value.

28. The motion estimating method according to claim 27, wherein the correcting of the motion vector comprises correcting a motion vector of the block in the boundary area to be an average vector having the greatest difference from the background motion vector among the calculated average vectors, when the block in the text area is in the boundary area.

29. The motion estimating method according to claim 19, wherein the correcting of the motion vector comprises:
calculating average vectors by projecting motion vectors of peripheral blocks of the block in an x-axis direction and a y-axis direction if the block is in the text area; and
calculating degrees of dispersion of the calculated average vectors, and determining that the block in the text area is in the boundary area if an average vector having the greatest dispersion degree among the average vectors is greater than a reference value.

30. The motion estimating method according to claim 29, wherein the correcting of the motion vector comprises correcting a motion vector of the block in the boundary area to be an average vector having the greatest difference from the background motion vector among the calculated average vectors, when the block in the text area is in the boundary area.

31. The motion estimating method according to claim 28, further comprising generating the frame to be interpolated on the basis of the corrected motion vector.

32. The motion estimating method according to claim 30, further comprising generating the frame to be interpolated on the basis of the corrected motion vector.

33. The motion estimating method according to claim 19, further comprising generating the frame to be interpolated on the basis of the corrected motion vector.
